(19) United States
(12) Patent Application Publication
(10) Pub. No.: US 2009/0059099 A1
(43) Pub. Date: Mar. 5, 2009

(54) ILLUMINATION DEVICE AND PROJECTION SYSTEM HAVING THE SAME

(75) Inventors: Alexander Evgenievich LINKOV, Moscow (RU); Maria Valerievna URUSOVA, Moscow (RU); Irina Vladimirovna SERGIEVSKAYA, Moscow (RU); Alexey Vladimirovich BRATISHCHEV, Moscow (RU)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/204,373

(22) Filed: Sep. 4, 2008

(30) Foreign Application Priority Data
Sep. 5, 2007 (RU) 2007133301
May 13, 2008 (KR) 10-2008-0044014

(51) Int. Cl. H04N 9/31; F21V 8/00

(52) U.S. Cl. 348/760; 362/235; 348/E09.025

(57) ABSTRACT

The illumination device includes a plurality of light source units and a plurality of optical concentrators facing the plurality of light source units and each having an entry surface, lateral surfaces, and an output surface. A color synthesizing unit synthesizes light emitted by the plurality of optical concentrators and includes two intersecting dichroic filters. A relay optical system transmits light synthesized by the color synthesizing unit to an illuminated surface.

### CROSS-REFERENCE TO RELATED PATENT APPLICATIONS

This application claims priority from the Russian Patent Application No. RU2007133301, filed Sep. 5, 2007, in the Russian Patent Office, and the Korean Patent Application No. 10-2008-0044014, filed May 13, 2008 in the Korean Intellectual Property Office, the disclosures of which are incorporated herein in their entireties by reference.

### BACKGROUND OF THE INVENTION

1. Field of the Invention

The present invention relates to an optical system, and more particularly, to an illumination device which can be used in various projection systems such as projectors or projection televisions (TV).

2. Description of the Related Art

At present, illumination systems based on color light emitting diodes (LED) are widely used. Generally, the combination of red, green, and blue light is used in illumination systems in which an optical concentrator and optical tools for synthesizing light from LED groups are used.

FIG. 1 illustrates a conventional projection illuminating device disclosed in the patent application publication JP P2000-180962. Referring to FIG. 1, the conventional projection illuminating device to provide uniform light to an illuminated surface includes three LED groups 1 each emitting red, green, and blue light. Three transparent blocks 10 face the LED groups 1, and uniformly mix light from the LED groups 1. A dichroic prism 4 having a cube shape synthesizes light from the LED groups 1. A condenser lens 6 transmits light synthesized by the dichroic prism 4 to the illuminated working surface of a light modulator 8. Because such conventional projection illuminating device includes the cube-shaped dichroic prism 4, its weight is large and a manufacturing cost is high.

An illumination system disclosed in the patent application publication US 2007/0064202 includes three LED groups, three optical concentrators, and a relay optical system synthesizing light from the three LED groups to transmit the synthesized light to an illuminated surface. The relay optical system includes three collector optical systems facing each of the three LEDS groups, two dichroic filters synthesizing light from the three LED groups, and a coupling optical system. The illumination system includes dichroic filters having a smaller weight and has a lower manufacturing cost as compared to the systems with the dichroic cubes.

However, in this illumination system, the two dichroic filters are spaced apart from each other by a predetermined distance. Also, many optical components are needed to maintain a high optical efficiency, which increases the size of the illumination system.

### SUMMARY OF THE INVENTION

The present invention provides an illumination device having a reduced size and/or weight. The complexity of a manufacturing process is also reduced and a high optical efficiency is realized.

According to an aspect of the present invention, there is provided an illumination device, the illumination device including: a plurality of light source units; a plurality of optical concentrators facing the plurality of light source units and each having an entry surface, lateral surfaces, and an output surface; a color synthesizing unit which synthesizes light emitted by the plurality of optical concentrators and includes first and second intersecting dichroic filters; and a relay optical system which transmits light synthesized by the color synthesizing unit to an illuminated surface.

Each of the plurality of light source units may include an array of a plurality of light emitting diodes (LEDs) having a common emission surface.

The common emission surface and the entry surface may be spaced apart from each other by a predetermined distance. A distance by which the emission surface and the entry surface are spaced apart from each other may be 0.0001 h or higher when a minimal aperture of the array of LEDs is h.

The color synthesizing unit may include a red dichroic filter including one plate and a blue dichroic filter including two plates.

A focusing surface of the relay optical system may be formed at a distance of 0.05 H or higher from the illuminated surface when a minimal aperture of the illuminated surface is H.

An angle formed between the entry surface and the lateral surface of the optical concentrator may be larger than 90°.

A cross-sectional shape of the optical concentrator may be the same as the shape of the illuminated surface.

The output surface of the optical concentrator may be convex or spherical.

According to another aspect of the present invention, there is provided a projection system, the projection system including: an illumination device according to an exemplary embodiment of the present invention; a light modulator which modulates light transmitted by the relay optical system to form an image and has a working surface formed as the illuminated surface; and a projection optical system which projects the image formed by the light modulator.

The optical modulator may be a reflection type display device such as a micromirror device.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a related art projection illuminating device;

FIG. 2A schematically illustrates an illumination device according to an exemplary embodiment of the present invention;

FIG. 2B illustrates a minimal aperture of a light source unit; and

FIG. 2C illustrates a minimal aperture of an illuminated surface illustrated in FIG. 2A; and

FIG. 3 schematically illustrates a projection system according to an exemplary embodiment of the present invention.

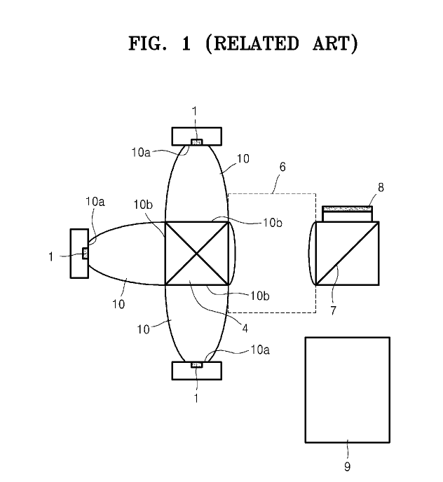

### DETAILED DESCRIPTION OF THE INVENTION

The present invention will now be described more fully with reference to the accompanying drawings, in which exemplary embodiments of the invention are shown. In the drawings, like reference numerals denote like elements, and the size of each element may be exaggerated for clarity and convenience.

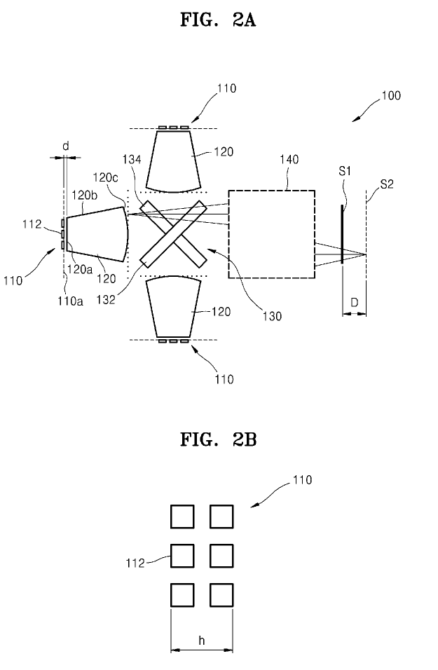

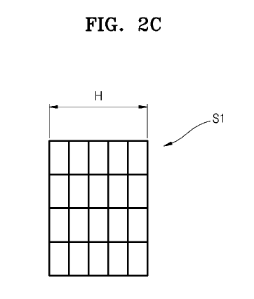

FIG. 2A schematically illustrates an illumination device 100 according to an exemplary embodiment of the present invention, and FIGS. 2B and 2C illustrate a minimal aperture of each of a plurality of light source units 110 and an illuminated surface S1 illustrated in FIG. 2A.

Referring to FIGS. 2A through 2C, the illumination device 100 according to an exemplary embodiment of the present invention is used to illuminate light on the illuminated surface S1. The illumination device 100 includes a plurality of light source units 110, a plurality of optical concentrators 120 respectively facing the light source units 110, a color synthesizing unit 130 synthesizing light emitted from the optical concentrators 120, and a relay optical system 140 transmitting light synthesized by the color synthesizing unit 130 to the illuminated surface S1.

The light source units 110 each includes a plurality of light emitting diodes (LED) 112 having a common emission surface 110a, for example. In FIG. 2A, the number of the light source units 110 is three, and each of the three light source units 110 emits different color light, for example, one of red, green, and blue light. The light source units 110 may be LEDs and other light source devices, for example, laser diodes (LD).

The optical concentrators 120 face respective light source units 110, gather light emitted from the light source units 110, mix light to receive uniform light, collimate and emit light. The optical concentrators 120 each includes an entry surface 120a, on which light emitted from the light source units 110 is incident, lateral surfaces 120b, from which light is totally reflected and mixed, and an output surface 120c, from which mixed light is emitted. The entry surface 120a is parallel to the common emission surface 110a of each of the light source units 110 and may be spaced apart from the common emission surface 110a by a distance d, to more effectively gather light emitted from the common emission surface 110a by the optical concentrator 120. The spaced distance d may be greater than approximately 0.0001 h when the minimal aperture of the light source units 110 is h. The distance d may be 0.01 μm or greater. Here, the minimal aperture is a short length of aperture dimension formed on an array of the LEDs 112, as illustrated in FIG. 2B.

Each optical concentrator 120 is formed of a transparent material having a relatively large refractive index, for example, acryl resin, glass, etc. The larger the refractive index of a material used in forming the optical concentrator 120, the smaller the angle of light refracted on the entry surface 120a and the greater the angle of light incident on the lateral surfaces 120b. Thus, the efficiency in which light is totally reflected on the lateral surfaces 120b increases. In addition, in an exemplary embodiment, an angle formed by the lateral surfaces 120b and the entry surface 120a is greater than 90° so that light incident on the entry surface 120a can be incident on the lateral surfaces 120b with a larger incidence angle. Thus, the efficiency of total reflection on the lateral surfaces 120b increases further.

Light incident on the optical concentrator 120 is totally reflected on the lateral surfaces 120b and is mixed. The mixed light is emitted from the output surface 120c. In this case, the output surface 120c may be formed to be convex toward an optical path. The output surface 120c may be spherical, for example.

The entry surface 120a and the output surface 120c of each optical concentrator 120 may be formed to resemble the shape of the illuminated surface S1. For example, the cross-sectional shape of the optical concentrator 120 may be substantially the same as the shape of the illuminated surface S1.

The color synthesizing unit 130 synthesizes different color light emitted from each of the light source units 110. In an exemplary embodiment, the color synthesizing unit 130 includes first and second intersecting dichroic filters 132, 134. For example, the first dichroic filter 132 may include a red dichroic filter including one plate. The second dichroic filter 134 may include a blue dichroic filter including two plates. The configuration of the color synthesizing unit 130 may be selected to substantially reduce the weight and size of the illustration device.

In an exemplary embodiment, the color synthesizing unit 130 may transmit light non-uniformly. As described above, the red dichroic filter 132 includes one plate, while the blue dichroic filter 134 includes two plates. The plates are spaced apart from each other by a predetermined distance and may cause an non-functional area of a filter to be generated in a red or green channel such that the size of the non-functional area is approximately the thickness of the plates.

Non-uniform transmission of light may affect the uniformity of the brightness in the illuminated surface S1. To reduce such effects, in an exemplary embodiment, a focusing surface S2 of the relay optical system 140 which transmits light synthesized by the color synthesizing unit 130 to the illuminated surface S1, is formed in the rear of the illuminated surface S1. The relay optical system 140 may include at least one lens. As illustrated in FIG. 2A, the focusing surface S2 of the relay optical system 140 may be spaced apart from the illuminated surface S1 by a distance D. The distance D may be 0.05 H or greater, where H is the minimal aperture of the illuminated surface S1. As illustrated in FIG. 2C, the illuminated surface S1 may be a working surface of a light modulator in which display elements are arranged in a two-dimensional array, for example. Here, the minimal aperture H is a short length of aperture dimension formed by the array of display elements.

The illumination device illustrated in FIGS. 2A through 2C has a numerical aperture (NA) of approximately 0.25, optical efficiency of approximately 35% or higher, and optical uniformity of 80% or higher.

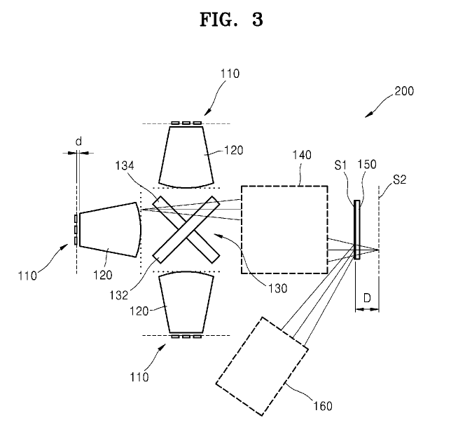

FIG. 3 schematically illustrates a projection system 200 according to an exemplary embodiment of the present invention. Referring to FIG. 3, the projection system 200 includes the plurality of light source units 110, the plurality of optical concentrators 120 respectively facing the light source units 110, the color synthesizing unit 130 synthesizing light emitted from the optical concentrators 120, the relay optical system 140 transmitting light synthesized by the color synthesizing unit 130 to the illuminated surface S1, a light modulator 150 modulating light transmitted by the relay optical system 140 to form an image, and a projection optical system 160 projecting the image formed by the light modulator 150 on a projection surface.

Although not shown, the projection system 200 may include controlling means such as an emission controller to control the emission timing of the light source units 110 and a modulation device controller to control the driving of the light modulator 150 according to an image signal.

Here, the light source units 110, the optical concentrators 120, the color synthesizing unit 130, and the relay optical system 140 are elements of the illumination device 100 illustrated in FIGS. 2A through 2C and thus, a detailed description thereof is omitted.

The light modulator 150 modulates light to form an image, and a working surface of the light modulator 150 is an illuminated surface S1. The light modulator 150 may be a reflection type display device that modulates illuminated light to display an image by controlling the reflection characteristic of a plurality of display elements arranged in a two-dimensional array on the illuminated surface S1. For example, a device, such as a digital micromirror device (DMD) in which a micromirror having an inclination angle able to be changed into two types of inclination angles corresponding to an ON state and an OFF state according to an image signal and arranged in the form of a two-dimensional lattice, may be used as the reflection type display device. In FIG. 3, a micromirror device is used as the light modulator 150. Light reflected by a micromirror having an inclination angle corresponding to an ON state is incident on the projection optical system 160 so that an image may be formed. Although not shown, light reflected by a micromirror having an inclination angle corresponding to an OFF state is directed toward a direction in which light is not incident on the projection optical system 160.

The projection optical system 160 projects the image formed by the light modulator 150 on a projection surface and may include at least one lens, for example.

In FIG. 3, light from the light modulator 150 is directly directed toward the projection optical system 160. However, if necessary, for example, an optical path converting member may be further provided on an optical path between the light modulator 150 and the projection optical system 160 so that an optical path from the relay optical system 140 to the optical modulator 150 and an optical path in which light from the light modulator 150 is directed toward the projection optical system 160 do not overlap with each other.

In addition, the light modulator 150 may be a liquid crystal on silicon (LCOS), which is a reflection type liquid crystal display (LCD), as a reflection type display device. In this case, a beam splitter may be further provided to separate an optical path from the relay optical system 140 to the light modulator 150 and an optical path 160 from the light modulator 150 to the projection optical system from each other.

An illumination system according to an exemplary embodiment includes a plurality of intersecting dichroic filters so that the size and weight of the illumination system may be effectively reduced. In addition, the shape and arrangement of an optical concentrator is improved so that an optical efficiency may be increased. Furthermore, a focusing surface of a relay optical system is spaced apart from an illuminated surface by a predetermined distance so that an optical uniformity in the illuminated surface may be improved.

A projection system according to an exemplary embodiment includes the illumination system so that the high-quality images may be generated with a simple configuration of the system.

While this invention has been particularly shown and described with reference to exemplary embodiments thereof, it will be understood by one skilled in the art that various changes in form and details may be made therein without departing from the spirit and scope of the invention as defined by the appended claims.

What is claimed is:

1. An illumination device comprising:
a plurality of light source units;
a plurality of optical concentrators facing the plurality of light source units, one of the plurality of the optical concentrators having an entry surface, lateral surfaces, and an output surface;
a color synthesizing unit which synthesizes light emitted by the plurality of optical concentrators and comprises a first dichroic filter and a second dichroic filter which intersects with the first dichroic filter; and
a relay optical system which transmits light synthesized by the color synthesizing unit to an illuminated surface.

2. The device of claim 1, wherein each of the plurality of light source units comprises an array of a plurality of light emitting diodes (LEDs) having a common emission surface.

3. The device of claim 2, wherein the common emission surface and the entry surface are spaced apart from each other by a predetermined distance.

4. The device of claim 3, wherein the predetermined distance is equal to or greater than 0.0001 h, where h is a minimal aperture of the array of the plurality of the LEDs.

5. The device of claim 1, wherein the first dichroic filter comprises a red dichroic filter including one plate and the second dichroic filter comprises a blue dichroic filter including two plates.

6. The device of claim 1, wherein a focusing surface of the relay optical system is formed at a distance of 0.05 H or greater from the illuminated surface, where H is a minimal aperture of the illuminated surface.

7. The device of claim 1, wherein an angle, which is formed between the entry surface and the lateral surface of one of the plurality of the optical concentrators, is greater than 90°.

8. The device of claim 1, wherein a cross-sectional shape of one of the plurality of the optical concentrators is substantially the same as a shape of the illuminated surface.

9. The device of claim 1, wherein the output surface of one of the plurality of the optical concentrators is convex.

10. The device of claim 9, wherein the output surface of one of the plurality of the optical concentrators is spherical.

11. A projection system comprising:
the illumination device of claim 1;
a light modulator which modulates light transmitted by the relay optical system to form an image and comprises a working surface formed as the illuminated surface; and
a projection optical system which projects the image formed by the light modulator.

12. The system of claim 11, wherein the optical modulator comprises a reflection type display device.

13. The system of claim 12, wherein the reflection type display device comprises a micromirror device.

14. The system of claim 11, wherein each of the plurality of light source units comprises an array of a plurality of light emitting diodes (LEDs) having a common emission surface.

15. The system of claim 14, wherein the common emission surface and the entry surface are spaced apart from each other by a predetermined distance.

16. The system of claim 15, wherein the predetermined distance is equal to or greater than 0.0001 h where h is a minimal aperture of the array of the plurality of the LEDs.

17. The system of claim 11, wherein the first dichroic filter comprises a red dichroic filter including one plate and the second dichroic filter comprises a blue dichroic filter including two plates.

18. The system of claim 11, wherein a focusing surface of the relay optical system is formed at a distance of 0.05 H or greater from the illuminated surface where H is a minimal aperture of the illuminated surface.

19. The system of claim 11, wherein an angle, which is formed between the entry surface and the lateral surface of the one of the plurality of optical concentrators, is greater than 90°.

20. The system of claim 11, wherein a cross-sectional shape of one of the plurality of the optical concentrators is substantially the same as a shape of the illuminated surface.

21. The system of claim 11, wherein the output surface of one of the plurality of the optical concentrators is convex.

22. The system of claim 21, wherein the output surface of one of the plurality of the optical concentrators is spherical.
